(19) United States
(12) Patent Application Publication
(10) Pub. No.: US 2025/0136419 A1
(43) Pub. Date: May 1, 2025

(54) JACK

(71) Applicant: Amir Arami, Mission Viejo, CA (US)

(72) Inventor: Amir Arami, Mission Viejo, CA (US)

(21) Appl. No.: 18/497,937

(22) Filed: Oct. 30, 2023

(51) Int. Cl. B66F 3/24

(52) U.S. Cl. CPC B66F 3/247; B66F 3/12; B60S 9/02

(57) ABSTRACT

According to an aspect of the present invention, there is provided a system for operating a vehicle jack, comprising: a jack according to the present invention; an input for an air inflation tube positioned in the actuator of the jack, wherein air received through the air inflation tube actuates the lifting mechanism of the jack; an air inflation tube connected to a motorized inflator; and a motorized inflator connected to a power source.

### BACKGROUND

Designed to help lift the weight of a vehicle, vehicle jacks have been known for over a hundred years. Yet, the patent literature discloses myriad variations, and improved jacks continue to be developed.

For example, U.S. Pat. No. 5,000,424 discloses a vehicle jack comprising a base with means for moving the jack smoothly on a ground, an upright shell located on the base, an upright hydraulic ram located inside the shell and including a cylinder construction and a hollow rod, a vehicle support for directly supporting the bottom of a vehicle to be jacked up, a hydraulic source for raising the cylinder construction, and a locking means for mechanically preventing the cylinder construction from lowering from a raised position. The cylinder construction may include an outer cylindrical wall, an intermediate, slidable cylindrical wall capable of being extended upwardly from the rest of the cylinder construction and having openings through any one of which a pin may be inserted to fix the intermediate cylindrical wall at a required height, and an inner cylindrical wall defining an inner cylinder chamber. The hollow rod is located inside the inner cylindrical wall, and is fixed to the base at its bottom and defines an inner oil path which is in communication with the cylinder chamber. The hydraulic source is in communication with the oil path and supplies a hydraulic oil through the oil path into the cylinder chamber to raise the cylinder construction to lift up a vehicle with the vehicle support. The locking means, for example, may comprise a thread formed on an outer circumference of the outer cylindrical wall of the cylinder construction and an annular stopper provided around the outer cylindrical wall and having at an inner surface thereof a thread which is in engagement with the thread on the outer cylindrical wall.

U.S. Pat. No. 8,141,850 discloses various embodiments of a vehicle jack including a base, an upright support mounted adjacent to and extending upwardly from the base, a toothed rack, a toothed bar pin, and a release handle. The toothed rack has a first end and a second end and defines a plurality of ratchet troughs therebetween, and the toothed rack is mounted adjacent the upright support. The ratchet assembly is adapted to move along a path defined by the upright support, and the toothed bar pin, which is mounted adjacent the ratchet assembly, is adapted to selectively engage a portion of the toothed rack adjacent one of the plurality of ratchet troughs as the ratchet assembly moves along the path. The release handle is mounted adjacent the second end of the toothed rack, and the release handle is adapted to selectively disengage the toothed bar pin from one of the plurality of ratchet troughs.

Nevertheless, jacks continue to be difficult to use, and many vehicle owners find it difficult and/or frightening to use a jack to replace a flat tire, for example. Further improvements in jacks which allow for easier and more convenient use continue to be desirable.

### SUMMARY OF INVENTION

Therefore, the present invention is a car jack for tire replacement that uses the portable tire air pump to plug into the jack and pump up the jack without having to do it manually.

According to an aspect of the present invention, there is provided to an aspect of the present invention, there is provided a system for operating a vehicle jack, comprising: a jack according to the present invention; an input for an air inflation tube positioned in the actuator of the jack, wherein air received through the air inflation tube actuates the lifting mechanism of the jack; an air inflation tube connected to a motorized inflator; and a motorized inflator connected to a power source.

According to another aspect of the present invention, there is provided a method for lifting a vehicle, comprising: providing a jack; positioning the jack under a vehicle; providing an input for an air inflation tube positioned in the actuator of the jack, wherein air received through the air inflation tube actuates the lifting mechanism of the jack; connecting the air inflation tube to the jack and to a motorized inflator; connecting the motorized inflator to a power source; activating the power source; actuating the lifting mechanism of the lack; and lifting the vehicle.

### BRIEF DESCRIPTION OF THE DRAWINGS

FIG. 1 illustrates a jack according to an embodiment of the present invention.

### DETAILED DESCRIPTION

Many people struggle with manual jacks. The jack of the present invention eliminates the need for physical exertion in lifting a car off the ground, for example, to change a tire. This is especially helpful to disabled individuals in wheelchairs, who use walkers, or use canes, all of whom cannot easily change a tire in an emergency situation.

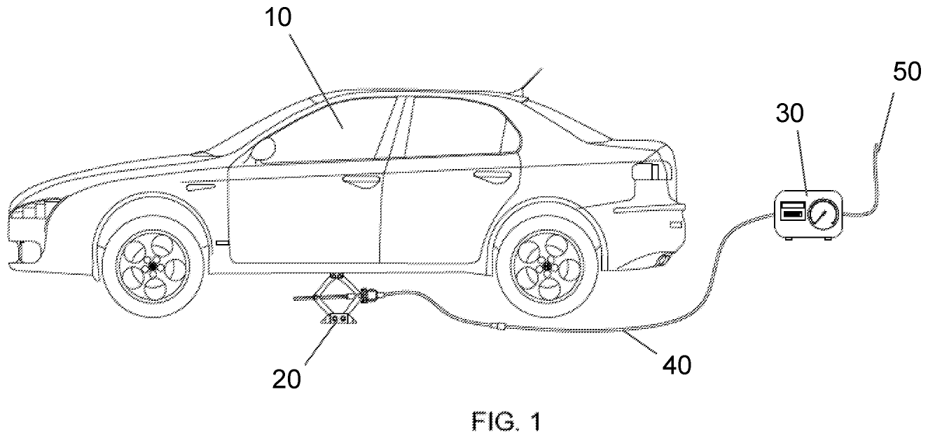

FIG. 1 illustrates the jack according to the present invention.

Vehicle 10 could be a vehicle with a flat tire, for example, and whose driver wishes to lift the vehicle in order to change the tire. Vehicle 10 has jack 20 positioned underneath the vehicle.

Contact points on jack 20 directly touch the undercarriage of vehicle 10. Vehicle 10 may have jacking points specifically configured to receive the contact points on jack 20.

Jack 20 is a jack according to the present invention. Jack 20 has an input for air inflation tube 40. When air is received from air inflation tube 40, the jack is actuated to lift vehicle 10.

Air inflation tube 40 connects to inflator 30. Inflator 30 uses an electric motor to power a compressor, which pumps air into air inflation tube 40. The electric motor can be powered by a rechargeable battery or an AC power supply. The jack can be used in conjunction with the existing portable tire inflator that plugs into the cigarette lighter. The air inflater will plug into the jack and pump the jack so the jack does not have to be lifted manually by the action of the user's hands and feet.

Jack 20 may be a scissor jack. Scissor jacks are the most portable and lightweight type of jack. They use a scissor mechanism to lift objects, making them ideal for roadside emergencies and smaller vehicles. The air received from air inflation tube 40 actuates the scissor mechanism and causes the scissor mechanism to lift the vehicle.

Some jacks of embodiments of the present invention are mechanical, while others are hydraulic. Most mechanical jacks use a screw or lever that would normally have to be cranked to operate, but with the present invention is actuated by the air flowing through air inflation tube 40. Hydraulic jacks use a hydraulic cylinder filled with pressure to create enough force to lift heavy loads. A hydraulic jack can also be actuated by air flowing through air inflation tube 40.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A system for operating a vehicle jack, comprising:
a jack;
an input for an air inflation tube positioned in the actuator of the jack, wherein air received through the air inflation tube actuates the lifting mechanism of the jack;
an air inflation tube connected to a motorized inflator; and
a motorized inflator connected to a power source.

2. The system for operating a vehicle jack of claim 1, wherein the jack is a mechanical jack.

3. The system for operating a vehicle jack of claim 1, wherein the jack is a hydraulic jack.

4. The system for operating a vehicle jack of claim 1, wherein the motorized inflator plugs into a power source in a vehicle.

5. The system for operating a vehicle jack of claim 1, wherein the motorized inflator has an internal battery.

6. The system for operating a vehicle jack of claim 1, wherein the motorized inflator connects to an external battery.

7. The system for operating a vehicle jack of claim 1, wherein the motorized inflator connects to an electrical outlet.

8. The system for operating a vehicle jack of claim 1, wherein the motorized inflator connects to a USB port.

9. A method for lifting a vehicle, comprising:
providing a jack;
positioning the jack under a vehicle;
providing an input for an air inflation tube positioned in the actuator of the jack, wherein air received through the air inflation tube actuates the lifting mechanism of the jack;
connecting the air inflation tube to the jack and to a motorized inflator;
connecting the motorized inflator to a power source;
activating the power source;
actuating the lifting mechanism of the lack; and
lifting the vehicle.
